(19) United States
(12) Patent Application Publication
(10) Pub. No.: US 2005/0254587 A1
(43) Pub. Date: Nov. 17, 2005

(54) Transmitting and receiving apparatuses for reducing a peak-to-average power ratio and an adaptive peak-to-average power ratio controlling method thereof

(75) Inventors: Jae-Hyoung Kim, Anyang-si (KR); Jae-Hwan Chang, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/937,243

(22) Filed: Sep. 9, 2004

(30) Foreign Application Priority Data
May 12, 2004 (KR) 2004-33423

(51) Int. Cl. H04K 1/10

(52) U.S. Cl. 375/260

(57) ABSTRACT

Transmitting and receiving apparatuses for PAPR reduction and an adaptive PAPR control method thereof are provided. Prior to transmission, the transmitting apparatus limits the peak of a multi-carrier modulated signal using a mapping function that increases an output value with an input value and converges the output value to a predetermined value. The receiving apparatus receives the peak-limited signal, recovers the peak of the signal using a demapping function of the mapping function, and recovers data from the peak-recovered signal according to the multi-carrier modulation scheme used. According to the adaptive PAPR control method, a scaling factor can be set variably for the mapping function and the demapping function according to a sub-carrier modulation scheme.

### PRIORITY

This application claims priority under 35 U.S.C. § 119 to an application entitled “Transmitting and Receiving Apparatuses for Reducing Peak-to-Average Power Ratio and Adaptive Peak-to-Average Power Ratio Controlling Method Thereof in a Communication System Using Multi-Carrier Modulation Scheme” filed in the Korean Intellectual Property Office on May 12, 2004 and assigned Serial No. 2004-33423, the contents of which are incorporated herein by reference.

### BACKGROUND OF THE INVENTION

1. Field of the Invention

The present invention relates generally to a multi-carrier modulation (MCM) communication system, and in particular, to an apparatus and method for reducing a peak-to-average power ratio (PAPR).

2. Description of the Related Art

MCM is a scheme in which data is transmitted in parallel on orthogonal sub-carriers instead of on a single carrier in a wide frequency band. MCM schemes include DMT (Discrete Multi-Tone) and OFDM (Orthogonal Frequency Division Multiplexing).

Because an MCM communication system transmits data on sub-carriers, the amplitude of a multi-carrier-modulated signal is a sum of the amplitudes of the sub-carriers. Therefore, the multi-carrier-modulated signal varies greatly in amplitude and its PAPR increases in proportion to the number of sub-carriers. When the sub-carriers have the same phase, the PAPR is very high. As a result, the signal is beyond the linear operation range of a high power amplifier (HPA) in a transmitter, and distorted after processing in the HPA. To reduce the signal distortion, all signals can be rendered to operate linearly by widening the linear range of an HPA, or a non-linear HPA can be made to operate in a linear range by dropping its operation point (back-off). These methods, however, show the drawbacks of increased cost or decreased power efficiency.

Accordingly, many PAPR reduction techniques have been proposed. For example, clipping is simply and widely implemented for OFDM signals. When a signal amplitude is greater than a predetermined level, it is clipped off to not exceed the predetermined level. Additionally, coding with a predetermined code to avoid sub-carriers having the same phase, symbol scrambling, etc. have been proposed.

Clipping, which is a kind of signal distortion, negatively affects BER (Bit Error Rate) and thus decreases BER performance. Further, other methods are hard to implement and require complex processing. Therefore, they are not viable for use in portable terminals.

### SUMMARY OF THE INVENTION

The present invention has been designed to substantially solve at least the above problems and/or disadvantages and to provide at least the advantages below. Accordingly, an object of the present invention is to provide transmitting and receiving apparatuses for PAPR reduction, which suppress BER performance degradation and are easily implemented, and an adaptive PAPR control method thereof.

Another object of the present invention is to provide transmitting and receiving apparatuses for PAPR reduction, which suppress BER performance degradation and are that applicable to portable terminals, and an adaptive PAPR control method thereof.

The above and other objects are achieved by providing transmitting and receiving apparatuses for PAPR reduction and an adaptive PAPR control method thereof. Prior to transmission, the transmitting apparatus limits the peak of a multi-carrier modulated signal using a mapping function that increases an output value with an input value and converges the output value to a predetermined value.

The receiving apparatus receives the peak-limited signal, recovers the peak of the signal using a demapping function of the mapping function, and recovers data from the peak-recovered signal according to the multi-carrier modulation scheme used.

According to the adaptive PAPR control method, a scaling factor can be variably set for the mapping function and the demapping function according to a sub-carrier modulation scheme.

### BRIEF DESCRIPTION OF THE DRAWINGS

The above and other objects, features, and advantages of the present invention will become more apparent from the following detailed description when taken in conjunction with the accompanying drawings in which:

FIG. 1 is a block diagram illustrating a transmitting apparatus according to an embodiment of the present invention;

FIG. 2 is a graph illustrating an exemplary mapping function applied to the present invention;

FIG. 3 is a block diagram of a receiving apparatus according to an embodiment of the present invention;

FIG. 4 is a graph illustrating exemplary mapping areas of the mapping function with respect to changes in scaling factor;

FIGS. 5 and 6 are graphs comparing modulation schemes in terms of performance with respect to changes in scaling factor;

FIG. 7 is a block diagram illustrating a transmitting/receiving apparatus in a base station (BS) according to an embodiment of the present invention;

FIG. 8 is a flowchart illustrating an adaptive PAPR control operation in a controller as illustrated in FIG. 7;

FIG. 9 is a block diagram of a transmitting/receiving apparatus in a portable terminal according to an embodiment of the present invention;

FIG. 10 is a flowchart illustrating an adaptive PAPR control operation in a controller as illustrated in FIG. 9; and

FIG. 11 is a block diagram illustrating a PAPR measurer.

### DETAILED DESCRIPTION OF THE PREFERRED EMBODIMENT

Preferred embodiments of the present invention will be described in detail herein below with reference to the accompanying drawings. In the following description, well-known functions or constructions are not described in detail because they would obscure the invention in unnecessary detail.

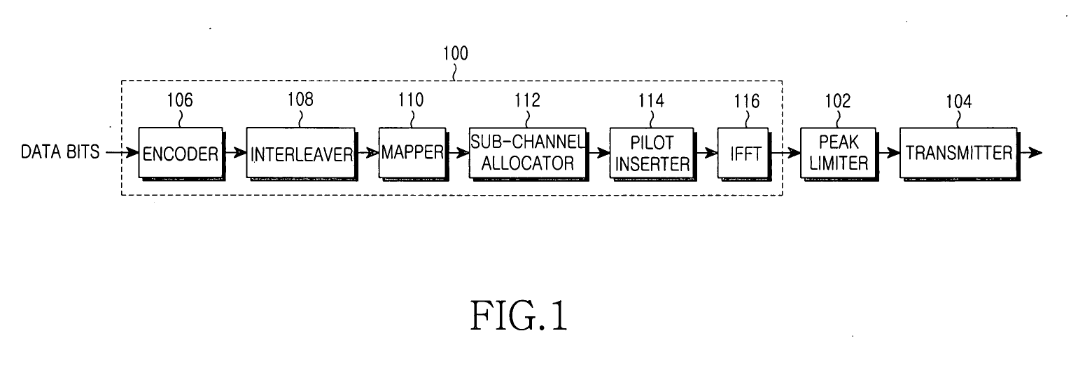

FIG. 1 is a block diagram illustrating a transmitting apparatus according to an embodiment of the present invention. The transmitting apparatus operates in a multi-carrier modulation scheme. Preferably, the transmitting apparatus is an OFDM transmitting apparatus based on IEEE (Institute of Electrical and Electronics Engineers) 802.16e. That is, according to an embodiment of the present invention, a, peak limiter 102 is implemented between an OFDM modulator 100 and a transmitter 104, which are components in an existing IEEE 802.16e OFDM transmitting apparatus.

Referring to FIG. 1, in the OFDM modulator 100, an encoder 106 encodes data bits to transmit using an FEC (Forward Error Correction) code and an interleaver 108 interleaves the code symbols. A mapper 110 modulates the interleaved symbols onto sub-carriers by QPSK (Quadrature Phase Shift Keying), 16 QAM (Quadrature Amplitude Modulation), or 64 QAM. A sub-channel allocator 112 allocates the modulated symbols to predetermined sub-channels, a pilot inserter 114 inserts pilots to the output of the sub-channel allocator 112, and an IFFT (Inverse Fast Fourier Transformer) 116 inverse-fast-Fourier-transforms the pilot-inserted signal. Accordingly, an OFDM modulated signal is generated.

While a conventional OFDM transmitting apparatus feeds the OFDM signal directly from the IFFT 116 to the transmitter 104, according to the present invention the OFDM signal is applied to the transmitter 104 via the peak limiter 102. The peak limiter 102 limits the peak power of the OFDM signal using a mapping function that increases an output level with an input level and converges the output level to a predetermined level. The peak-limited OFDM signal is transmitted through the transmitter 104.

The mapping function can be an exponential function or a log function by which an output level increases with an input level and converges to a predetermined level. According to an embodiment of the present invention, a hyperbolic tangent function, (tan h) is used as the mapping function.

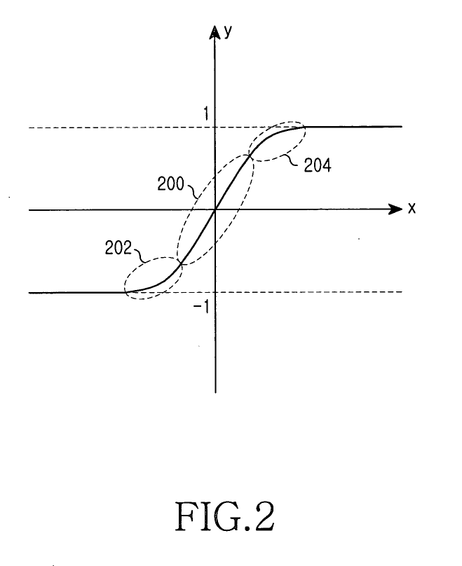

FIG. 2 is a graph illustrating an example of the mapping function applied to the present invention. The level of the OFDM signal received at the peak limiter 102 from the IFFT 116 is denoted by x. The output level y for the input level x is tan h(x). Thus, the graph is about y=tan h(x).

Referring to FIG. 2, even as x increases, y converges to −1 or 1. Therefore, x does not exceed a predetermined level. Depending on the level of x, y has a linear area 200 or a non-linear area 202 or 204. When x is a relatively small value within the linear area 200, y linear varies with x. However, if x is a relatively large value within the non-linear range 202 or 204, y non-linearly varies with x.

Therefore, the use of tan h(x) having the above characteristics as the mapping function for the OFDM signal received at the peak limiter 102 from the IFFT 116 enables the peak limiter 102 to output an OFDM signal at a relatively low level that is equal to or less than a predetermined threshold, even if the input OFDM signal has a high amplitude. The peak limitation reduces the PAPR.

Additionally, the peak limitation is easily implemented because the peak of the OFDM signal is limited using the mapping function alone. While the aforementioned clipping method clips off the amplitude of a signal at a predetermined level, if it is higher than the predetermined level, thereby increasing signal distortion, the inventive peak limitation relies on the non-linear characteristic of the mapping function, thereby reducing signal distortion and thus suppressing BER performance degradation.

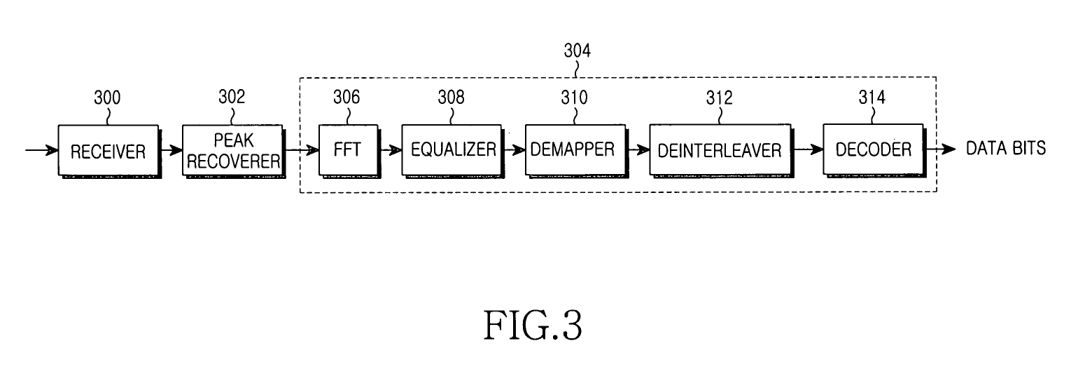

FIG. 3 is a block diagram illustrating a receiving apparatus according to an embodiment of the present invention. The receiving apparatus operates in a multi-carrier modulation scheme. Preferably, the receiving apparatus is an OFDM receiving apparatus based on IEEE 802.16e. That is, according to an embodiment of the present invention, a peak recoverer 302 is added between a receiver 300 and an OFDM modulator 304, which are components in an existing IEEE 802.16e OFDM receiving apparatus.

Referring to FIG. 3, the receiver 300 receives a signal with a peak that is limited by the peak limiter 102 from the transmitting apparatus as illustrated in FIG. 1. The peak recoverer 302 recovers the peak of the OFDM signal from the receiver 300 using a demapping function tan h⁻¹ (x) of the mapping function tan h(x).

In the OFDM demodulator 304 an FFT (Fast Fourier Transformer) 306 fast-Fourier-transforms the OFDM signal received from the peak recoverer 302, an equalizer 308 compensates the FFT signal for channel distortion, a demapper 310 demodulates the compensated signal, a deinterleaver 312 deinterleaves the demodulated signal, and a decoder 314 decodes the interleaved signal. Accordingly, original data bits are recovered.

As described above, the transmitting apparatus illustrated in FIG. 1 limits the peak of an OFDM signal using the mapping function prior to transmission, thereby reducing PAPR. The receiving apparatus illustrated in FIG. 3 recovers the peak of the OFDM signal using the demapping function prior to OFDM demodulation, thereby reducing BER performance degradation encountered with the conventional clipping method. The peak limitation and recovery are easily achieved by applying the mapping function and the demapping function to the OFDM signal in the transmitting apparatus and the receiving apparatus, respectively. Therefore, the peak limitation and recovery is easily viable for portable terminals.

Further, through experimentation, the inventors of the present invention have determined that BER performance varies with the mapping areas of the mapping function tan h(x) with respect to x in the peak limiter 102. Specifically, to minimize BER performance degradation, it is preferable to appropriately adjust the mapping areas of tan h(x) according to a sub-carrier modulation scheme, that is, one of QPSK, 16 QAM and 64 QAM used in the OFDM transmitting apparatus of FIG. 1. A scaling factor is needed to adjust the tan h(x) mapping areas. By setting the scaling factor a, the output value y of the mapping function is tan h(ax).

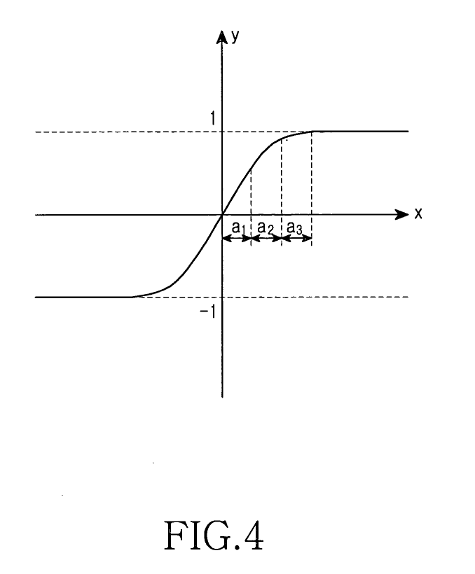

An example of mapping areas that vary with the scaling factor a is illustrated in FIG. 4. Referring to FIG. 4, a1, a2, and a3 denote mapping areas determined by the scaling factor a. If a=100, the mapping area is a1, if a=150, the mapping area is a2, if a=200, the mapping area is a3.

BER performance was simulated by changing the scaling factor a of tan h(ax) for QPSK, 16 QAM, and 64 QAM. The simulation result revealed that QPSK, 16 QAM, and 64 QAM exhibit best BER performance under the scaling factors of 200, 150 and 100, respectively.

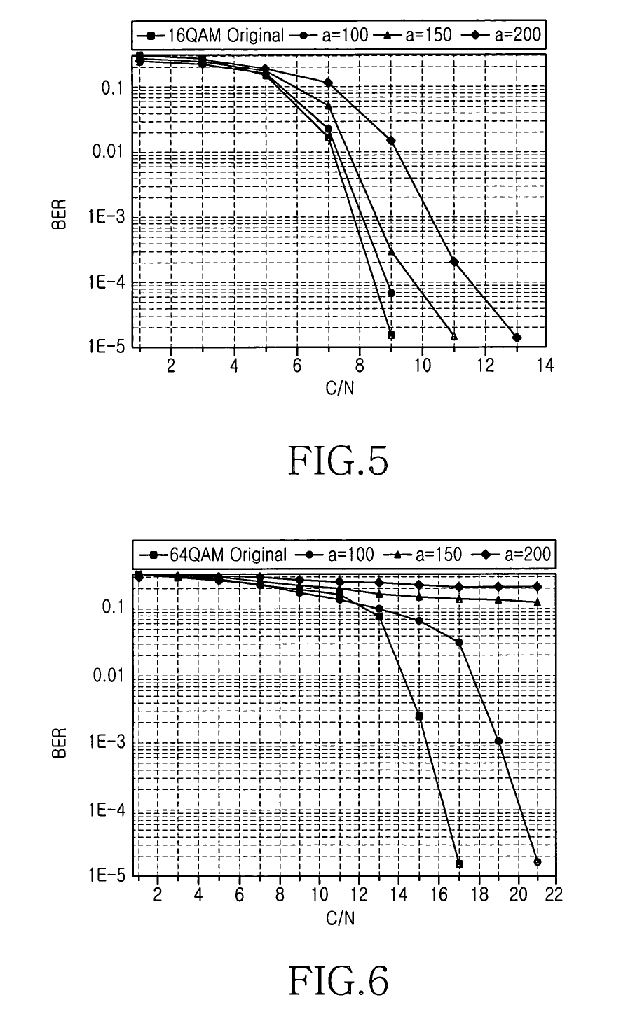

FIGS. 5 and 6 exemplarily illustrate the BER performance simulation. FIG. 5 illustrates BER performance when the sub-carrier modulation is 16 QAM and FIG. 6 illustrates BER performance when the sub-carrier modulation is 64 QAM. In FIGS. 5 and 6, “16 QAM Original” is compared with 16 QAM under the scaling factors of 100, 150, and 200 and “64 QAM Original” with 64 QAM under the scaling factors of 100, 150, and 200, in terms of BER versus carrier-to-noise ratio (C/N). 16 QAM Original and 64 QAM Original are 16 QAM and 64 QAM without the mapping function applied.

Referring to FIG. 5, for 16 QAM, when the scaling factor is 150, BER performance is closer to that of 16 QAM Original than when the scaling factors 100 or 200.

Therefore, the scaling factor of 150 offers the best BER performance to 16 QAM. Referring to FIG. 6, for 64 QAM, when the scaling factor is 100, BER performance is closer to that of 64 QAM Original than when the scaling factors 150 or 200.Therefore, the scaling factor of 100 offers the best BER performance to 64 QAM.

The simulation of FIGS. 5 and 6 was performed on an AWGN (Additive White Gaussian Noise) channel to set a communication environment close to a real one. Ideally, without the AWGN channel, there is no BER loss. Also, if a mapping function other than tan h is utilized, the scaling factor a that offers the best BER performance is changed.

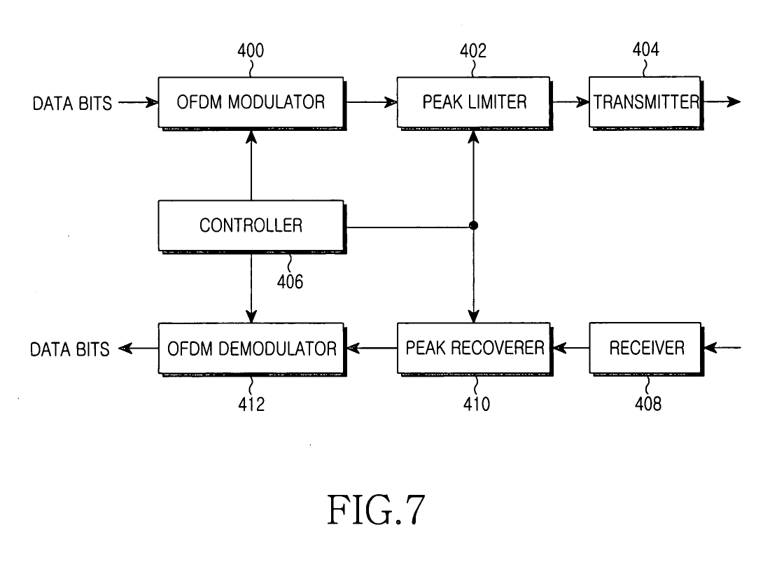

FIG. 7 is a block diagram illustrating a transmitting/receiving apparatus in a base station (BS) according to another embodiment of the present invention. Adaptive PAPR control through use of a variable scaling factor depending on sub-carrier modulation according to the present invention, is applied to the transmitting/receiving apparatus of the BS in an IEEE 802.16e communication system. Only blocks essential to the description of the present invention in the transmitting/receiving apparatus of the BS that operates in OFDM are schematically illustrated. The transmitting/receiving apparatus further includes a peak limiter 402 between an OFDM modulator 400 and a transmitter 404, and a peak recoverer 410 between a receiver 408 and an OFDM demodulator 412. The OFDM modulator 400 and the OFDM demodulator 412 are similar in configuration to the OFDM modulator 100 illustrated in FIG. 1 and the OFDM demodulator 304 illustrated in FIG. 3, respectively.

Referring to FIG. 7, the peak limiter 402, unlike the peak limiter 102 of FIG. 1, limits the peak of an OFDM signal received from the OFDM modulator 400 using a mapping function by which a variable scaling factor is used according to a sub-carrier modulation scheme, under the control of a controller 406. The peak recoverer 410, unlike the peak recoverer 302 illustrated in FIG. 3, recovers the peak of an OFDM signal received from the receiver 408 using a demapping function by which a variable scaling factor is used according to a sub-carrier modulation scheme, under the control of the controller 406. The sub-carrier modulation scheme is one of three sub-carrier modulations according to IEEE 802.16e, i.e., QPSK, 16 QAM and 64 QAM.

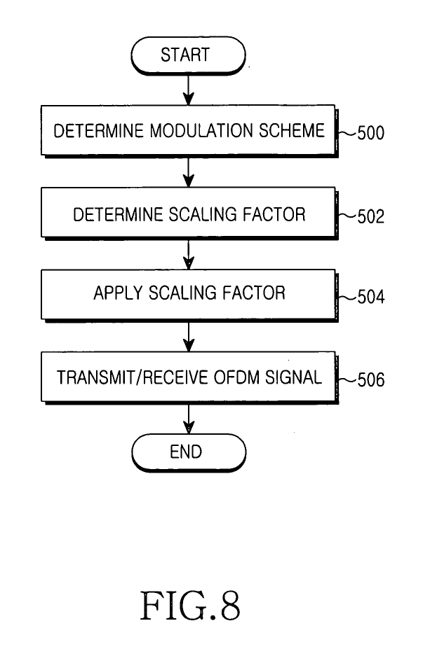

FIG. 8 is a flowchart illustrating an adaptive PAPR control operation in the controller 406 according to an embodiment of the present invention. Referring to FIG. 8, the controller 406 determines which of the sub-carrier modulation scheme used in the OFDM modulator 410 among QPSK, 16 QAM, and 64 QAM in step 500, and determines a scaling factor corresponding to the determined sub-carrier modulation scheme in step 502. For example, the controller 406 selects a scaling factor of 200 for QPSK, a scaling factor of 150 for 16 QAM, and a scaling factor of 100 for 64 QAM.

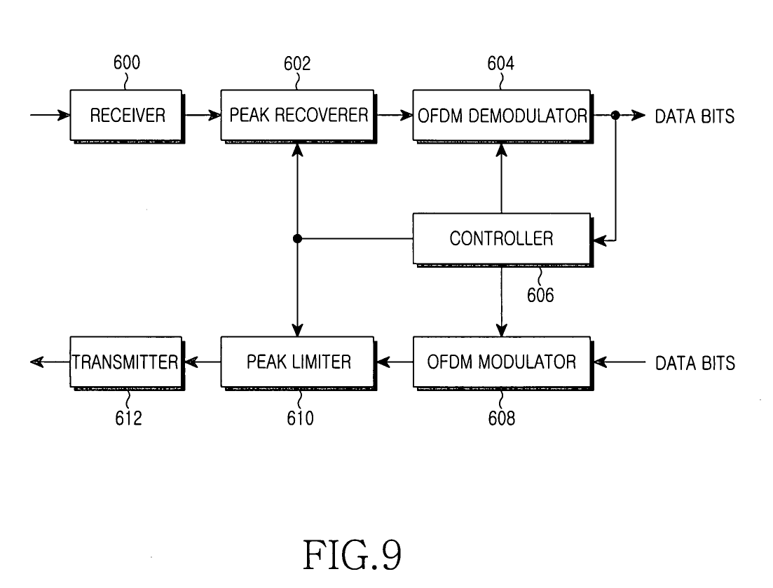

In step 504, the controller 406 sets the determined scaling factor for the peak limiter 402 and the peak recoverer 410 as the scaling factor of the mapping function and the demapping function. The controller 406 then transmits/receives an OFDM signal to/from a portable terminal having a transmitting/receiving apparatus as illustrated in FIG. 9 in step 506. Accordingly, the peak of a transmit OFDM signal is limited according to the sub-carrier modulation scheme and the peak of a receive OFDM signal is recovered according to the sub-carrier modulation scheme.

FIG. 9 is a block diagram illustrating a transmitting/receiving apparatus in a portable terminal according to another embodiment of the present invention. Adaptive PAPR control by use of a variable scaling factor, depending on sub-carrier modulation, according to the present invention, is applied to the transmitting/receiving apparatus of the portable terminal in the IEEE 802.16e communication system. As indicated above, only blocks essential to the description of the present invention in the transmitting/receiving apparatus of the portable terminal that operates in OFDM are schematically illustrated. The transmitting/receiving apparatus further includes a peak recoverer 602 between a receiver 600 and an OFDM demodulator 604, and a peak limiter 610 between an OFDM modulator 608 and the transmitter 612. The OFDM modulator 608 and the OFDM demodulator 604 are similar in configuration to the OFDM modulator 100 illustrated in FIG. 1 and the OFDM demodulator 304 illustrated in FIG. 3, respectively.

Referring to FIG. 9, the peak limiter 610, unlike the peak limiter 102 of FIG. 1, limits the peak of an OFDM signal received from the OFDM modulator 608 using a mapping function by which a variable scaling factor is used according to a sub-carrier modulation scheme, under the control of a controller 606. The peak recoverer 602, unlike the peak recoverer 302 illustrated in FIG. 3, recovers the peak of an OFDM signal received from the receiver 600 using a demapping function by which a variable scaling factor is used according to a sub-carrier modulation scheme, under the control of the controller 606.

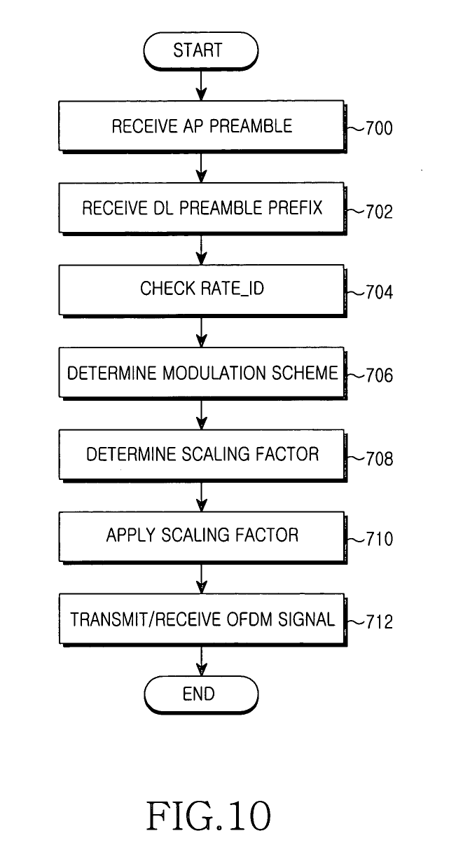

FIG. 10 is a flowchart illustrating an adaptive PAPR control operation in the controller 606 according to an embodiment of the present invention. Referring to FIG. 10, the controller 606 determines which of the sub-carrier modulation schemes is applied to the current received OFDM signal among QPSK, 16 QAM, and 64 QAM in steps 700 through 706. The sub-carrier modulation scheme is known from data included in the first downlink frame received from the BS according to IEEE 802.16e. In the first downlink frame, a DL (DownLink) Frame Prefix includes Rate_ID, No_OFDM_symbols, No_subchanenls, and Prefix_CS. Rate_ID indicates a sub-carrier modulation scheme and a coding rate (modulation/coding) used for DL_MAP, as illustrated in Table 1. Preferably, the portable terminal includes the information listed in Table 1. The coding rate refers to a coding rate used in the encoder 106 of the transmitting apparatus as illustrated in FIG. 1.

TABLE 1

| Rate_ID | Modulation/coding |
|---|---|
| 0 | QPSK 1/2 |
| 1 | QPSK 3/4 |
| 2 | 16QAM 1/2 |
| 3 | 16QAM 3/4 |
| 4 | 64QAM 2/3 |
| 5 | 64QAM 3/4 |
| 6-15 | Reserved |

When the portable terminal starts to communicate with the transmitting/receiving apparatus of the BS illustrated in FIG. 7, the controller 606 receives an access point (AP) preamble in the first downlink frame in step 700, receives the following DL Frame Prefix in step 702, checks Rate_ID in DL Frame Prefix in step 704, and determines the sub-carrier modulation scheme corresponding to Rate_ID referring to Table 1 in step 706.

The Rate_ID is recovered from OFDM signal by OFDM demodulator 604 and provided to the controller 606. Because the portable terminal cannot know the sub-carrier modulation scheme of the received OFDM signal until it determines the sub-carrier modulation scheme corresponding to Rate_ID, the scaling factor of the demapping function is not set. Therefore, the controller 606 sets the scaling factor to a value corresponding to a predetermined one of QPSK, 16 QAM and 64 QAM, or to any other predetermined value in a default mode before determining the sub-carrier modulation scheme.

In step 708, the controller 606 determines a scaling factor corresponding to the determined sub-carrier modulation scheme. For example, the controller 606 selects a scaling factor of 200 for QPSK, a scaling factor of 150 for 16 QAM, and a scaling factor of 100 for 64 QAM. In step 710, the controller 606 sets the determined scaling factor for the peak limiter 610 and the peak recoverer 602 as the scaling factor of the mapping function and the demapping function. The controller 606 then transmits/receives an OFDM signal to/from the BS having the transmitting/receiving apparatus illustrated in FIG. 7 in step 712. Accordingly, the peak of a transmit OFDM signal is limited according to the sub-carrier modulation scheme and the peak of a receive OFDM signal is recovered according to the sub-carrier modulation scheme.

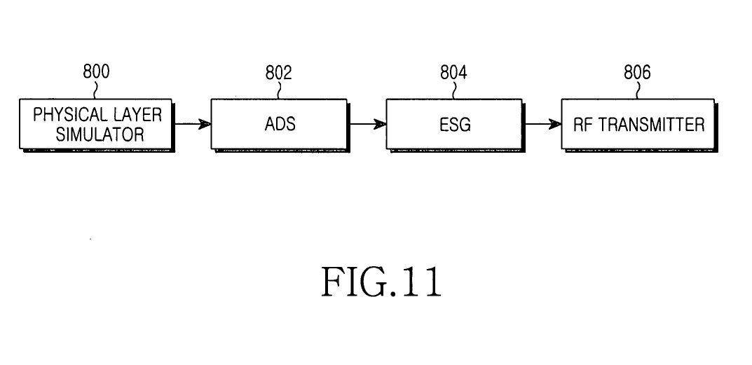

For reference, the change of the PAPR of a transmitting/receiving apparatus to which the inventive adaptive PAPR control is applied was measured by a PAPR measurer as illustrated in FIG. 11. Referring to FIG. 11, a physical layer simulator 800 having the above-described mapping function generates an OFDM bit stream. An ADS (Advanced Design System) 802, which is a CAD (Computer-Aided Design) tool of Agilent generates I and Q bits for the input of the OFDM bit stream. An ESG (Electronic Signal Generator) 804, which is an RF (Radio Frequency) signal generator of Agilent, upconverts the I and Q bits to an RF frequency of 1.95 GHz in a CDMA (Code Division Multiple Access) frequency band. An RF transmitter 806 of Agilent measures the PAPR of the RF signal at a CCDF (Complementary Cumulative Distribution Function) of 0.1%. The measuring of the PAPR in this configuration enables the ESG 804 to achieve the RF frequency and RF power, thereby leading to the same effects achieved by using a power amplifier in a transmitter of an actual transmitting device. Therefore, the PAPR measurement in the environment is closest to the actual PAPR measurement.

Table 2 below lists PAPR measurements for QPSK, 16 QAM, and 64 QAM, each under the scaling factors of 100, 150 and 200. In Table 2, “a” denotes a scaling factor and “Original” denotes a modulation with a mapping function not applied thereto.

TABLE 2

| | Original | a = 100 | a = 150 | a = 200 |
|---|---|---|---|---|
| QPSK | 8.30 dB | 7.63 dB | 7.14 dB | 6.73 dB |
| 16QAM | 8.32 dB | 7.64 dB | 7.17 dB | 6.75 dB |
| 64QAM | 8.34 dB | 7.67 dB | 7.19 dB | 6.75 dB |

As noted from Table 2, for QPSK, PAPR=6.73 dB when a=200.Therefore, a gain of 1.57 dB is obtained, as compared to “Original”. For 16 QAM, PAPR=7.17 dB when a=150, resulting in a gain of 1.15 dB, relative to “Original”. For 64 QAM, PAPR=7.67 dB when a=100, resulting in a gain of 0.67 dB relative to “Original”.

Therefore, the adaptive PAPR control for optimize BER performance according to the used sub-carrier modulation scheme further reduces PAPR and minimizes BER performance degradation, as compared to when a mapping function alone is used without a variable scaling factor.

While the present invention has been shown and described with reference to certain preferred embodiments thereof, they are mere exemplary applications. Specifically, while the multi-carrier modulation has been described in the context of OFDM in the embodiments of the present invention, the present invention is also applicable to any other MCM communication systems using, for example, (DMT).

Additionally, the mapping function tan h can be replaced by a different mapping function as long as it increases an output level with an input level and converges the output level to a predetermined level. Accordingly, when the mapping function or the communication system to which the present invention is applied, or the used sub-carrier modulation scheme is changed, the scaling factor is correspondingly adjusted.

Further, while the transmitting/receiving apparatuses illustrated in FIGS. 7 and 9 limit the peak of a transmit OFDM signal using a mapping function and recover the peak of a received OFDM signal using a demapping function, the peak limitation and peak recovery can also be performed in the same manner when the transmitting apparatus is separated from the receiving apparatus. If BER performance does not matter, the receiving apparatus can operate without the peak recoverer.

Therefore, it will be understood by those skilled in the art that various changes in form and details may be made therein without departing from the spirit and scope of the present invention as defmed by the appended claims.

1. A transmitting apparatus for reducing a peak-to-average power ratio (PAPR) in a communication system using a multi-carrier modulation scheme, comprising:
a modulator for modulating data to be transmitted in the multi-carrier modulation scheme;
a peak limiter for limiting a peak of the multi-carrier modulated signal received from the modulator using a mapping function for increasing an output value with an input value and converging the output value to a predetermined value; and
a transmitter for transmitting the peak-limited signal.

2. The transmitting apparatus of claim 1, wherein the mapping function is tan h(x) with respect to an input value x.

3. The transmitting apparatus of claim 1, wherein the multi-carrier modulation scheme is orthogonal frequency division multiplexing (OFDM).

4. A receiving apparatus for reducing a peak-to-average power ratio (PAPR) in a communication system using a multi-carrier modulation scheme, comprising:
a receiver for receiving a signal, which is modulated in the multi-carrier modulation scheme and of which, a peak is limited using a mapping function for increasing an output value with an input value and converging the output value to a predetermined value;
a peak recoverer for recovering the limited peak of the received signal using a demapping function of the mapping function; and
a demodulator for recovering data from the peak-recovered signal in the multi-carrier modulation scheme.

5. The receiving apparatus of claim 4, wherein the mapping function is tan h(x) with respect to an input value x.

6. The receiving apparatus of claim 4, wherein the multi-carrier modulation scheme is orthogonal frequency division multiplexing (OFDM).

7. A transmitting apparatus for reducing a peak-to-average power ratio (PAPR) in a communication system using a multi-carrier modulation scheme, comprising:
a modulator for modulating data to be transmitted in the multi-carrier modulation scheme;
a peak limiter for limiting a peak of the multi-carrier modulated signal received from the modulator using a mapping function with a variable scaling factor, for increasing an output value with an input value and converging the output value to a predetermined value;
a controller for determining the variable scaling factor of the mapping function according to a sub-carrier modulation scheme; and
a transmitter for transmitting the peak-limited signal.

8. The transmitting apparatus of claim 7, wherein the mapping function is tan h(ax) with respect to an input value x and a is the scaling factor.

9. The transmitting apparatus of claim 7, wherein the multi-carrier modulation scheme is orthogonal frequency division multiplexing (OFDM).

10. A receiving apparatus for reducing a peak-to-average power ratio (PAPR) in a communication system using a multi-carrier modulation scheme, comprising:
a receiver for receiving a signal which is modulated in the multi-carrier modulation scheme and of which a peak is limited using a mapping function with a scaling factor varying according to a sub-carrier modulation scheme, for increasing an output value with an input value and converging the output value to a predetermined value;
a peak recoverer for recovering the limited peak of the received signal using a demapping function of the mapping function;
a demodulator for recovering data from the peak-recovered signal in the multi-carrier modulation scheme; and
a controller for determining the scaling factor of the demapping function according to the sub-carrier modulation mode.

11. The receiving apparatus of claim 10, wherein the mapping function is tan h(ax) with respect to an input value x and a is the scaling factor.

12. The transmitting apparatus of claim 10, wherein the multi-carrier modulation scheme is orthogonal frequency division multiplexing (OFDM).

13. A transmitting apparatus for reducing a peak-to-average power ratio (PAPR) in a communication system using a multi-carrier modulation scheme, comprising:
a modulator for modulating data to be transmitted in the multi-carrier modulation scheme;
a peak limiter for limiting a peak of the multi-carrier modulated signal received from the modulator using a mapping function with a variable scaling factor, for increasing an output value with an input value and converging the output value to a predetermined value;
a transmitter for transmitting the peak-limited signal; and
a controller for determining a sub-carrier modulation scheme from sub-carrier modulation information included in recovered data of a received multi-carrier modulated signal and determining the scaling factor corresponding to the sub-carrier modulation scheme.

14. The transmitting apparatus of claim 13, wherein the mapping function is tan h(ax) with respect to an input value x and a is the scaling factor.

15. The transmitting apparatus of claim 13, wherein the multi-carrier modulation scheme is orthogonal frequency division multiplexing (OFDM).

16. The transmitting apparatus of claim 15, wherein the sub-carrier modulation information is a Rate_ID in a first downlink frame.

17. A receiving apparatus for reducing a peak-to-average power ratio (PAPR) in a communication system using a multi-carrier modulation scheme, comprising:
a receiver for receiving a signal which is modulated in the multi-carrier modulation scheme and of which a peak is limited using a mapping function with a scaling factor varying according to a sub-carrier modulation scheme, for increasing an output value with an input value and converging the output value to a predetermined value;
a peak recoverer for recovering the limited peak of the received signal using a demapping function of the mapping function;
a demodulator for recovering data from the peak-recovered signal in the multi-carrier modulation scheme; and
a controller for determining the sub-carrier modulation scheme from sub-carrier modulation information included in the recovered data and determining the scaling factor corresponding to the sub-carrier modulation scheme.

18. The receiving apparatus of claim 17, wherein the mapping function is tan h(ax) with respect to an input value x and a is the scaling factor.

19. The transmitting apparatus of claim 17, wherein the multi-carrier modulation scheme is orthogonal frequency division multiplexing (OFDM).

20. The transmitting apparatus of claim 19, wherein the sub-carrier modulation information is a Rate_ID in a first downlink frame.

21. A method of adaptively reducing a peak-to-average power ratio (PAPR) in a communication system using a multi-carrier modulation scheme, comprising the steps of:
determining a sub-carrier modulation scheme;
determining a variable scaling factor for a mapping function according to the sub-carrier modulation scheme, the mapping function increasing an output value with an input value and converging the output value to a predetermined value;
limiting a peak of a multi-carrier modulated signal to be transmitted using the mapping function with the determined scaling factor; and
transmitting the peak-limited signal.

22. The method of claim 21, further comprising the steps of:
receiving the peak-limited signal;
recovering the limited peak of the received signal using a demapping function of the mapping function; and
recovering data from the peak-recovered signal in the multi-carrier modulation scheme.

23. The method of claim 22, wherein the sub-carrier modulation scheme is determined from sub-carrier modulation information included in the recovered data.

24. The method of claim 23, wherein the mapping function is tan h(ax) with respect to an input value x and a is the scaling factor.

25. The method of claim 23, wherein the multi-carrier modulation scheme is OFDM.

26. The method of claim 25, wherein the sub-carrier modulation information is a Rate_ID in a first downlink frame.

27. The method of claim 21, wherein the mapping function is tan h(ax) with respect to an input value x and a is the scaling factor.

28. The method of claim 21, wherein the multi-carrier modulation scheme is orthogonal frequency division multiplexing (OFDM).
